(19) United States
(12) Patent Application Publication
(10) Pub. No.: US 2014/0376823 A1
(43) Pub. Date: Dec. 25, 2014

(54) AUTOMATED NOTIFICATION OF IMAGES SHOWING COMMON CONTENT

(71) Applicant: Nokia Corporation, Espoo (FI)

(72) Inventors: Yan Qing Cui, Helsinki (FI); Mikko Honkala, Espoo (FI); Jari Kangas, Tampere (FI); Dhaval Vyas, JL Enschede (NL)

(21) Appl. No.: 14/376,419

(22) PCT Filed: Feb. 4, 2013
(86) PCT No.: PCT/FI2013/050115

§ 371 Date: Aug. 2, 2014

(30) Foreign Application Priority Data
Feb. 9, 2012 (GB) 1202234.9

(51) Int. Cl. G06F 17/30; G06K 9/62

(52) U.S. Cl. CPC G06F 17/30274; G06K 9/6215; G06K 9/6202
USPC 382/219

(57) ABSTRACT

A photo notification system i comprises one or more mobile terminals, a data communications network, and a photo sharing platform. The photo sharing platform is configured to compare a received reference image (6.1), associated with a first user, with one or more stored images associated with other users. The platform identifies an object or scene of interest in the reference image (6.2), and compares the identified object or scene of interest with objects or scenes of interest in the one or more stored images (6.3) to identify common content having an appearance change (6.5). In such case, a notification message is sent to the first user referencing or comprising the stored image(s) having the identified changed appearance (6.7).

### FIELD OF THE INVENTION

This invention relates to an apparatus and method for the automatic notification of images showing common content to users.

### BACKGROUND TO THE INVENTION

It is common for users to upload images to network- or cloud-based image repositories, such as Flikr™ or Picasa™. This can be done directly from user terminal such as a smartphone having a camera capability or by transferring images to another processing device such as a tablet computer, personal computer (PC) or laptop, and uploading therefrom.

Uploaded images are viewable by other users of the network. Images of interest to a user are located using conventional browsing techniques, entering textual search terms and/or manual interaction with search results and hyperlinks. This browsing requires at least several inputs at the user terminal and corresponding data communication steps over the network. Images, particularly photographs, can have large file sizes and so the amount of data transferred over the network can be significant.

For example, when a user takes a photograph using their smartphone, it is implicit that the object, which may be a person, scene or location is of interest to that user. Users are often interested in how objects, scenes or locations have changed over time, for example by searching old photographs of the same object and/or subsequently browsing for new photographs. The aforementioned conventional browsing techniques are time consuming and will often identify photographs of the same or very similar appearance to their own photograph(s) which tend not to be of interest.

### SUMMARY OF THE INVENTION

A first aspect of the invention provides apparatus comprising:
means for accessing one or more stored images;
means for receiving a reference image associated with a user;
image processing means for:
   identifying an object or scene of interest in the reference image;
   comparing the identified object or scene of interest with objects or scenes of interest in the one or more stored images to identify common content having an appearance change; and
   communicating means for communicating automatically to the user associated with the reference image a notification message referencing or comprising the stored image(s) having the identified changed appearance in common content.

The image processing means may be configured automatically to identify the object or scene of interest using a predetermined algorithm upon receiving the reference image.

The image processing means may be configured to identify the object or scene of interest using selection data manually entered by the associated user and received with the reference image.

The image processing means may be configured automatically to quantify the appearance change in common content, and the communicating means may be configured to communicate the notification message only if the quantified change is above a predetermined amount. Here, the communicating means may be further configured only to communicate the notification message if there are a predetermined number of other stored images having the same or substantially similar content to the matched image.

The or each stored image may be associated with a user, and the communicating means may be further configured automatically to communicate a second notification message referencing or comprising the reference image to user(s) associated with the stored image(s) having the changed appearance in common content. Here, the image processing means may be further configured to identify stored images having comment content with the received reference image which is of the same or similar appearance, and the communicating means may be further configured automatically to communicate the second notification message to said user(s) only if a predetermined minimum number of such same or similar appearance images have been identified.

A second aspect of the invention provides apparatus comprising:
means for accessing one or more stored images associated with one or more users;
means for receiving a reference image;
image processing means for:
   identifying an object or scene of interest in the reference image;
   comparing the identified object or scene of interest with objects or scenes of interest in the one or more stored images to identify common content having an appearance change; and
   communicating means for communicating automatically to the or each user associated with the stored image(s) a notification messaging referencing or comprising the reference image.

The image processing means may be configured automatically to identify the object or scene of interest using a predetermined algorithm upon receiving the reference image.

The image processing means may be configured to identify the object or scene of interest using selection data manually entered by a user associated with the reference image.

The image processing means may be configured automatically to quantify the appearance change in common content, and the communicating means may be configured to communicate the notification message only if the quantified change is above a predetermined amount.

The image processing means may be further configured to identify stored images having common content with the received reference image which is of the same or similar appearance, and the communicating means may be further configured automatically to communicate the notification message to said user(s) only if a predetermined number of stored images having similar content have been identified.

The apparatus may further comprise means for receiving the reference image from mobile terminals over a wireless network and means for transmitting the notification message to mobile terminals over said wireless network.

The invention also provides a mobile communications device configured for use with the apparatus above, comprising:

means for storing and transmitting a new image to the apparatus;

means responsive to transmitting the new image for receiving automatically from the apparatus the notification message for display on a user interface.

A third aspect of the invention provides a method comprising:
accessing one or more stored images;
receiving a reference image associated with a user;
identifying an object or scene of interest in the reference image;
comparing the identified object or scene of interest with objects or scenes of interest in the one or more stored images to identify common content having an appearance change; and
communicating automatically to the user associated with the reference image a notification message referencing or comprising the stored image(s) having the identified changed appearance in common content.

The method may comprise identifying the object or scene of interest comprises using a predetermined algorithm upon receiving the reference image.

The method may comprise identifying the object or scene of interest comprises using selection data manually entered by the associated user and received with the reference image.

The method may comprise quantifying the appearance change in common content, and communicating the notification message only if the quantified change is above a predetermined amount. This method may comprise communicating the notification message only if there are a predetermined number of other stored images having the same or substantially similar content to the matched image.

The or each stored image may be associated with a user, and the method may comprise communicating a second notification message referencing or comprising the reference image to user(s) associated with the stored image(s) having the changed appearance in common content. This method may comprise identifying stored images having comment content with the received reference image which is of the same or similar appearance, and automatically communicating the second notification message to said user(s) only if a predetermined minimum number of such same or similar appearance images have been identified.

A fourth aspect of the invention provides a method comprising:
accessing one or more stored images associated with one or more users;
receiving a reference image;
identifying an object or scene of interest in the reference image;
comparing the identified object or scene of interest with objects or scenes of interest in the one or more stored images to identify common content having an appearance change; and
communicating automatically to the or each user associated with the stored image(s) a notification messaging referencing or comprising the reference image.

The method may comprise identifying the object or scene of interest using a predetermined algorithm upon receiving the reference image.

The method may comprise identifying the object or scene of interest using selection data manually entered by a user associated with the reference image.

to The method may comprise quantifying the appearance change in common content, and communicating the notification message only if the quantified change is above a predetermined amount. This method may comprise identifying stored images having common content with the received reference image which is of the same or similar appearance, and communicating the notification message to said user(s) only if a predetermined number of stored images having similar content have been identified.

The method may comprise receiving the reference image from mobile terminals over a wireless network and transmitting the notification message to mobile terminals over said wireless network.

The method may be performed on a mobile communications terminal.

The invention also provides a computer program comprising instructions that when executed by a computer apparatus control it to perform the method above.

A fifth aspect of the invention provides a non-transitory computer-readable storage medium having stored thereon computer-readable code, which, when executed by computing apparatus, causes the computing apparatus to perform a method comprising:
accessing one or more stored images;
receiving a reference image associated with a user;
identifying an object or scene of interest in the reference image;
comparing the identified object or scene of interest with objects or scenes of interest in the one or more stored images to identify common content having an appearance change; and
communicating automatically to the user associated with the reference image a notification message referencing or comprising the stored image(s) having the identified changed appearance in common content.

A sixth aspect of the invention provides apparatus, the apparatus having at least one processor and at least one memory having computer-readable code stored thereon which when executed controls the at least one processor:
to access one or more stored images;
to receive a reference image associated with a user;
to identify an object or scene of interest in the reference image;
to compare the identified object or scene of interest with objects or scenes of interest in the one or more stored images to identify common content having an appearance change; and
to communicate automatically to the user associated with the reference image a notification message referencing or comprising the stored image(s) having the identified changed appearance in common content.

A seventh aspect of the invention provides a non-transitory computer-readable storage medium having stored thereon computer-readable code, which, when executed by computing apparatus, causes the computing apparatus to perform a method comprising:
accessing one or more stored images associated with one or more users;
receiving a reference image;
identifying an object or scene of interest in the reference image;
comparing the identified object or scene of interest with objects or scenes of interest in the one or more stored images to identify common content having an appearance change; and
communicating automatically to the or each user associated with the stored image(s) a notification messaging referencing or comprising the reference image.

An eighth aspect of the invention provides apparatus, the apparatus having at least one processor and at least one memory having computer-readable code stored thereon which when executed controls the at least one processor:
to access one or more stored images associated with one or more users;
to receive a reference image;
to identify an object or scene of interest in the reference image;
to compare the identified object or scene of interest with objects or scenes of interest in the one or more stored images to identify common content having an appearance change; and
to communicate automatically to the or each user associated with the stored image(s) a notification messaging referencing or comprising the reference image.

### BRIEF DESCRIPTION OF THE DRAWINGS

Embodiments of the invention will now be described, by way of example only, with reference to the accompanying drawings, in which:

FIG. 1 is a schematic view of a data network including mobile terminal(s) and a photo sharing platform embodying aspects of the invention;

FIG. 2 is a perspective view of a mobile terminal shown in FIG. 1;

FIG. 3 is a schematic diagram illustrating components of the FIG. 2 mobile terminal and their interconnection;

FIG. 4 is a schematic diagram illustrating components of the photo sharing platform shown in FIG. 1;

FIG. 5 is a schematic diagram illustrating certain functional-level components of the photo sharing platform of FIGS. 1 and 4;

FIG. 6 is a flow diagram indicating processing steps performed by the photo sharing platform of FIGS. 1 and 4 in a first embodiment of the invention;

FIG. 7 is a flow diagram indicating processing steps performed by the photo sharing platform of FIGS. 1 and 4 in a second embodiment of the invention;

FIG. 8 shows different images showing common content, associated with different users, which is useful for understanding the invention; and

FIG. 9 is a schematic view of a user interface of the mobile terminal shown in FIG. 2.

### DETAILED DESCRIPTION OF PREFERRED EMBODIMENTS

Embodiments described herein relate to an apparatus and method for automatically notifying users of changes in images which depict an object, scene or location captured by the same or other users at a different time.

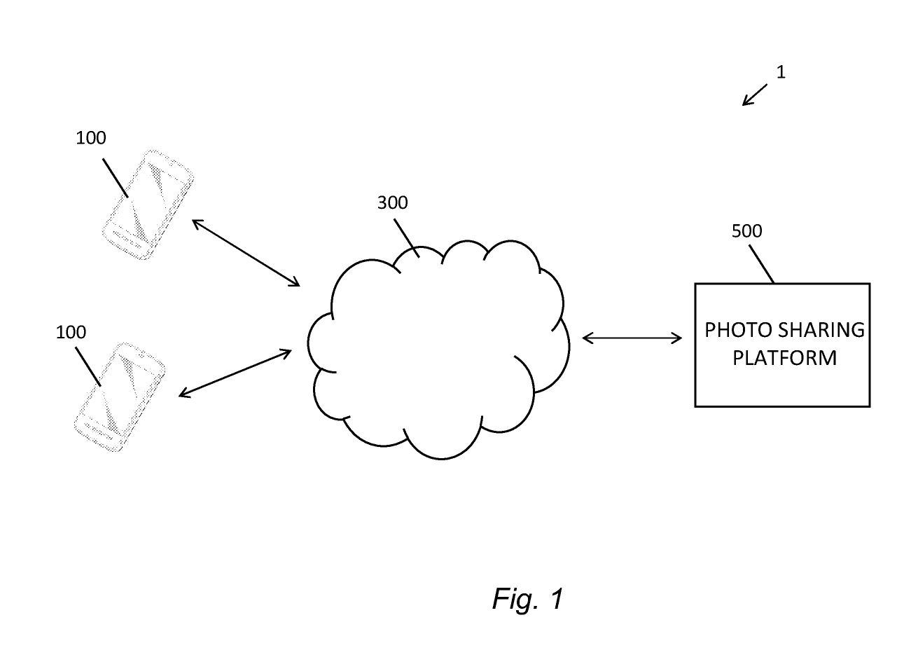

Referring firstly to FIG. 1, a photo notification system 1 is shown. The photo notification system 1 comprises one or more mobile terminals 100, a data communications network 300, e.g. the Internet, and a photo sharing platform 500. In use, users of the mobile terminals 100 upload photographs to the photo sharing platform 500, although other processing terminals such as PDAs, tablets, PCs and laptops can perform uploading. Data communications also takes place from the photo sharing platform 500 to the mobile terminals 100, as will be explained below.

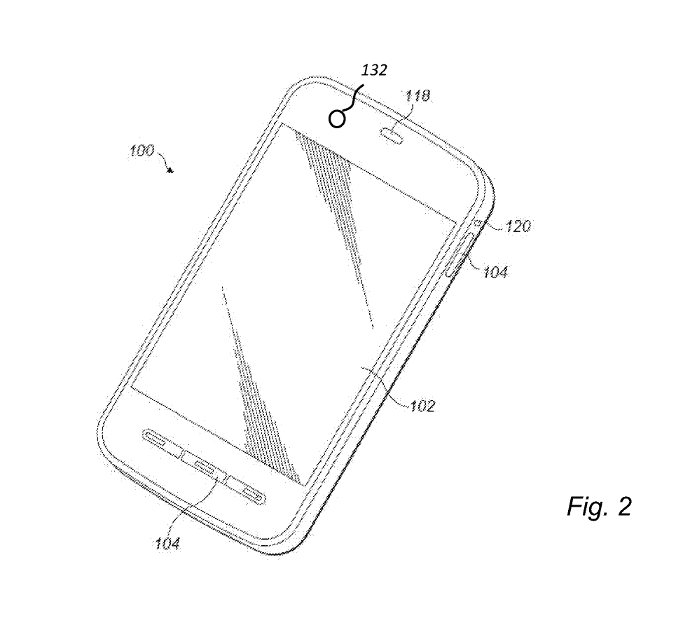

Referring to FIG. 2, a mobile terminal 100 is shown. The exterior of the terminal 100 has a touch sensitive display 102, hardware keys 104, a speaker 118 and a headphone port 120.

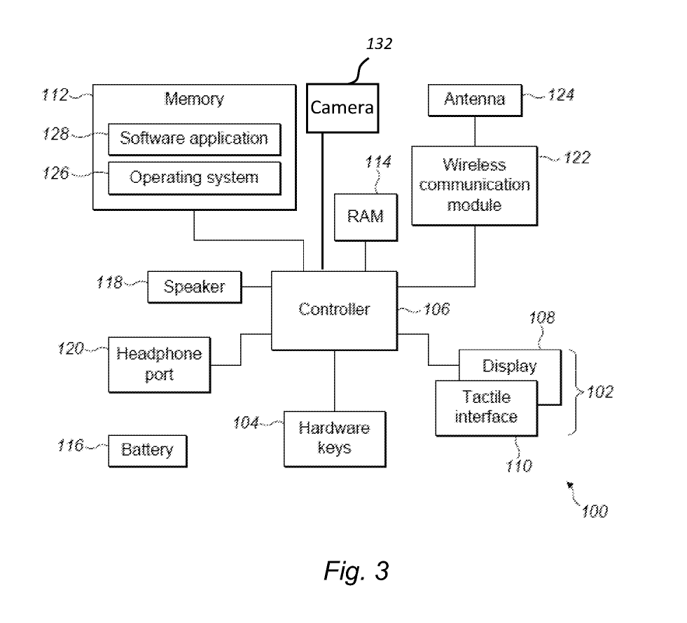

FIG. 3 shows a schematic diagram of the components of terminal 100. The terminal 100 has a controller 106, a touch sensitive display 102 comprised of a display part 108 and a tactile interface part 110, the hardware keys 104, a memory 112, RAM 114, a speaker 118, the headphone port 120, a wireless communication module 122, an antenna 124, a camera 132 (on the rear side) and a battery 116. The controller 106 is connected to each of the other components (except the battery 116) in order to control operation thereof.

The memory 112 may be a non-volatile memory such as read only memory (ROM) a hard disk drive (HDD) or a solid state drive (SSD). The memory 112 stores, amongst other things, an operating system 126 and may store software applications 128. The RAM 114 is used by the controller 106 for the temporary storage of data. The operating system 126 may contain code which, when executed by the controller 106 in conjunction with RAM 114, controls operation of each of the hardware components of the terminal.

The controller 106 may take any suitable form. For instance, it may be a microcontroller, plural microcontrollers, a processor, or plural processors.

The terminal 100 may be a mobile telephone or smartphone, a personal digital assistant (PDA), a portable media player (PMP), a portable computer or any other device capable of running software applications and providing audio outputs. In some embodiments, the terminal 100 may engage in cellular communications using the wireless communications module 122 and the antenna 124. The wireless communications module 122 may be configured to communicate via several protocols such as GSM, CDMA, UMTS, Bluetooth and IEEE 802.11 (Wi-Fi).

The display part 108 of the touch sensitive display 102 is for displaying images and text to users of the terminal and the tactile interface part 110 is for receiving touch inputs from users.

As well as storing the operating system 126 and software applications 128, the memory 112 may also store multimedia files such as music and video files. A wide variety of software applications 128 may be installed on the terminal including web browsers, radio and music players, games and utility applications. Some or all of the software applications stored on the terminal may provide audio outputs. The audio provided by the applications may be converted into sound by the speaker(s) 118 of the terminal or, if headphones or speakers have been connected to the headphone port 120, by the headphones or speakers connected to the headphone port 120.

In some embodiments the terminal 100 may also be associated with external software applications not stored on the terminal. These may be applications stored on a remote server device and may run partly or exclusively on the remote server device. These applications can be termed cloud-hosted applications. The terminal 100 may be in communication with the remote server device in order to utilise the software application stored there. This may include receiving audio outputs provided by the external software application.

The photo sharing platform 500 shown in FIG. 1 is one such cloud-hosted application, which will be described in detail below.

In some embodiments, the hardware keys 104 are dedicated volume control keys or switches. The hardware keys may for example comprise two adjacent keys, a single rocker switch or a rotary dial. In some embodiments, the hardware keys 104 are located on the side of the terminal 100.

The software applications 128 stored on the memory 112 include a dedicated photo notification application (PNA) which can be configured to run automatically when the camera 132 is operated and/or which can be run independently of the camera from the user interface of the operating system. The PNA performs the following non-exhaustive list of functions:
(1) the browsing of photographs stored on the memory 112;
(2) the automatic transfer of newly captured photographs to the photo sharing platform 500;
(3) the manual transfer of photographs stored on the memory 112 to the photo sharing platform 500;
(4) the browsing of photographs stored remotely at the photo sharing platform 500;
(5) the receipt and display of notification messages received from the photo sharing platform 500; and
(6) the downloading of photographs from the photo sharing platform 500.

The PNA, when run, communicates with the photo sharing platform 500.

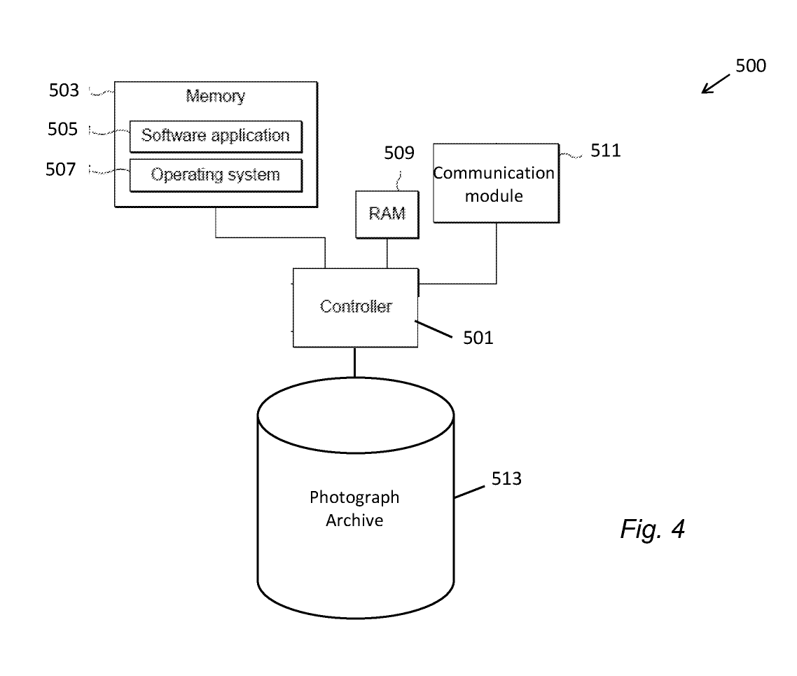

FIG. 4 shows a schematic diagram of the components of the photo sharing platform 500. The platform 500 has a controller 501, a memory 503, RAM 509, a communication module 511 and a photograph archive 513. The controller 501 is connected to each of the components (except the battery 116) in order to control operation thereof.

The memory 503 may be a non-volatile memory such as read only memory (ROM) a hard disk drive (HDD) or a solid state drive (SSD). The memory 503 stores, amongst other things, an operating system 507 and may store software applications 505. The RAM 509 is used by the controller 501 for the temporary storage of data. The operating system 507 may contain code which, when executed by the controller 501 in conjunction with RAM 509, controls operation of each of the hardware components of the terminal.

Similarly, the photograph archive 513 may be a non-volatile memory such as read only memory (ROM) a hard disk drive (HDD) or a solid state drive (SSD).

The controller 501 may take any suitable form. For instance, it may be a microcontroller, plural microcontrollers, a processor, or plural processors.

The photograph archive 513 stores photographs uploaded by users, whether from the mobile terminals 100, or other means, over the network 300. Each user of the photo sharing platform 500 is identified either by a username or a unique identifier associated with their terminal 100. Photos uploaded by a particular user or from a particular terminal 100 are therefore stored in the photograph archive 513 with their associated username or identifier.

The software application 505 stored on the memory 503 controls the photo sharing functionality of the platform 500. When new photographs are uploaded to the platform 500, objects and/or scenes of interest are identified, extracted and stored in association with each photograph.

Object or scene of interest identification can be performed automatically using known techniques. Such techniques may include facial detection, blob detection, edge detection and/or interest point detection. The latter technique is employed, for example, in Microsoft's Photosynth™ software application.

Object or scene of interest identification can also be aided by information entered manually at the user device, e.g. the mobile terminal 100. Users can, using the PNA user interface, indicate a part of the photograph that is of interest and this indication is transferred with the photograph to the platform 500, which subsequently identifies the object or scene of interest using this indication.

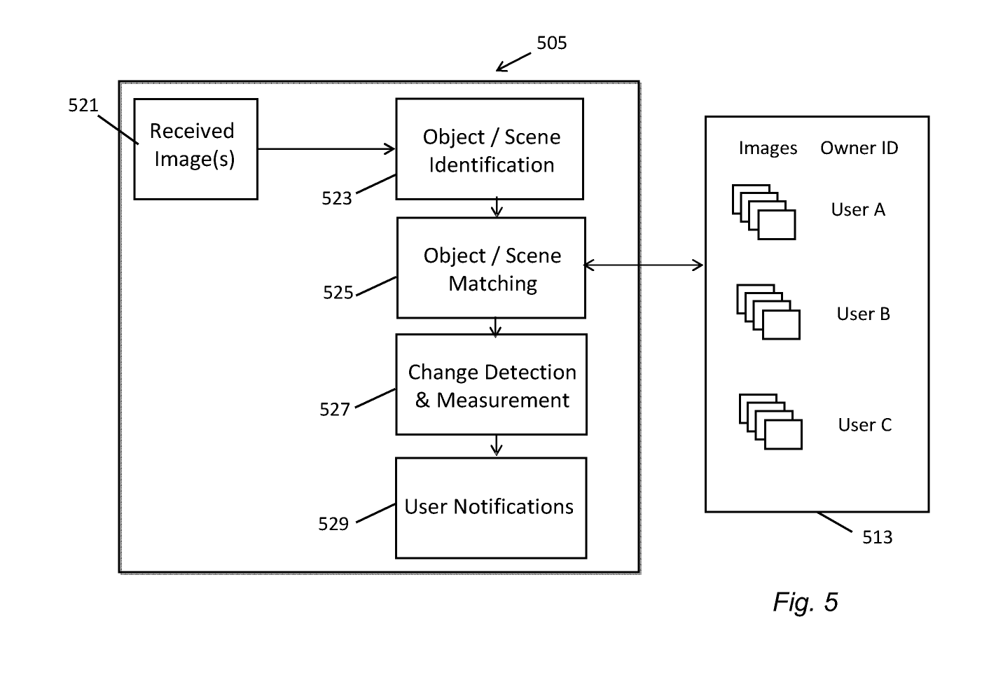

FIG. 5 shows functional modules of the software application 505 when run on the controller 501.

A received image 521 is first applied to an object or scene identification module 523, as mentioned above. The identified and extracted object or scene is then applied to an object or scene matching module 525 wherein the image 521 undergoes a matching step to identify the same object or scene in one or more other photographs stored in the photograph archive 513. Microsoft's abovementioned Photosynth application is also configured to perform said matching, the process generally involving comparing points of interest in the received image 521 with each other image to identify a match or correlation.

If a match is identified by the object or scene matching module 525, a change detection and measurement module 527 is configured to quantify differences between the common object or scene in the received image 521 and in the or each stored image in the photograph archive 513.

A notification module 529 is configured to send notification messages and/or photographs to selected users' terminals 100 in dependence on, amongst other criteria, the quantified differences determined in the change detection and measurement module 527. Such notification messages may be sent for instance by email, SMS or they may be pushed to the PNA application. The notification message may comprise a link to relevant photographs and/or thumbnail versions of the relevant photographs.

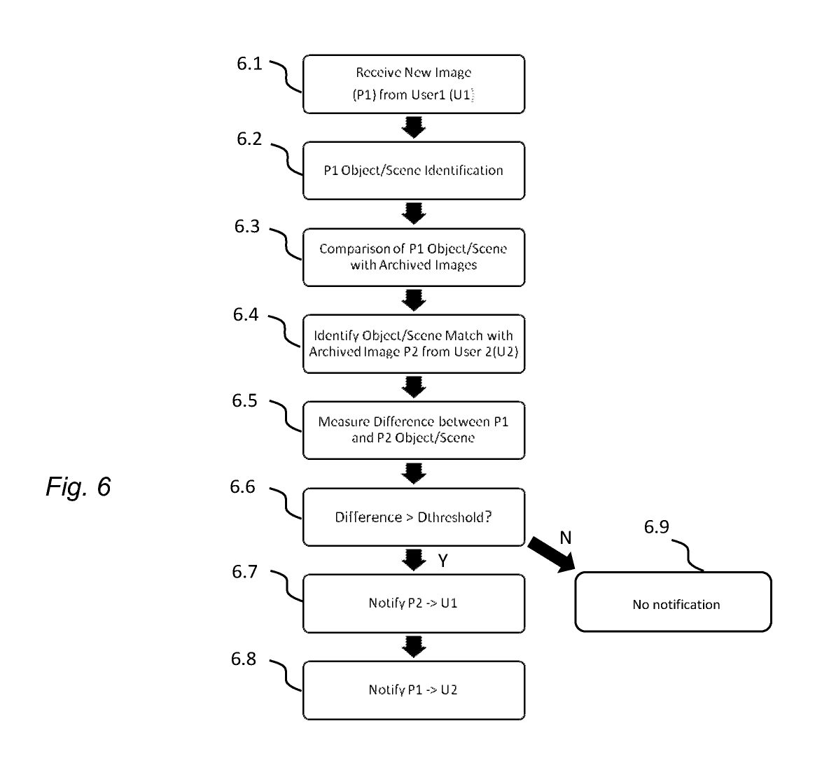

Referring to FIG. 6, processing steps performed by the software application 505 on the photo sharing platform 500 will now be described in relation to a first embodiment.

In a first step 6.1, a new image is received from a user; for ease of explanation, the image is referred to as P1 and the user as U1. In this embodiment, U1 is the user of a mobile terminal 100 shown in FIG. 1 and P1 has been uploaded using the network 300. Note that the term ‘new’ does not require the image to have just been captured; rather it means that the image is being newly presented to the photo sharing platform 500 and could, in fact, have been stored on the user terminal 100 for some time and is currently being browsed on the PNA application or has just been uploaded to the platform 500.

In step 6.2, object or scene identification is performed on P1. Here, one of the above known algorithms is used to identify an object or scene and to extract features for use in the subsequent step 6.3 which compares the extracted features for said object or scene with features for objects or scenes in each of the images stored in the photograph archive 513.

In step 6.4, a match between P1 and one or more of the stored images is identified; here we assume that P1 matches with P2 on the basis that the same object or scene has been identified, for example the same person (using facial recognition) or a well-known landmark or building. The user or owner associated with P2, U2 is also identified.

In step 6.5, the difference between the common object or scene in P1 and P2 is quantified. It may be that the common object or scene is identical, which would be of little or no interest to U1 or U2. A numerical value is assigned to the ‘difference’ between the common object or scene, with zero meaning the object or scene is identical, and a higher number being indicative of significant differences. A range of zero to one hundred might be employed for this purpose.

In step 6.6, it is determined whether the quantified difference is greater than a predetermined threshold, Dthreshold, for example thirty. If so, in step 6.7, the older image P2 stored in the photograph archive 513 is notified to U1. This notification can take a number of forms, including for example transmitting an email or SMS to an account or mobile number associated with U1 including an identifier or link to the relevant image P2. Alternatively, or additionally, the actual image P2 can be pushed automatically to U1's mobile terminal 100 when they open the PNA application.

If the quantified difference is not greater than Dthreshold, then no notification is sent, as indicated by step 6.9.

In a subsequent step 6.8, the user or owner U2 associated with the stored image P2 is notified about P1.

The photo sharing platform 500 is therefore configured automatically to notify users of existing images or photographs having common content to their own images or photographs, but only where a predetermined degree of change is identified which the user is therefore more likely to be interested in. No laborious and data intensive browsing operations are required over the network 300 in order to view changes in objects or scenes of interest.

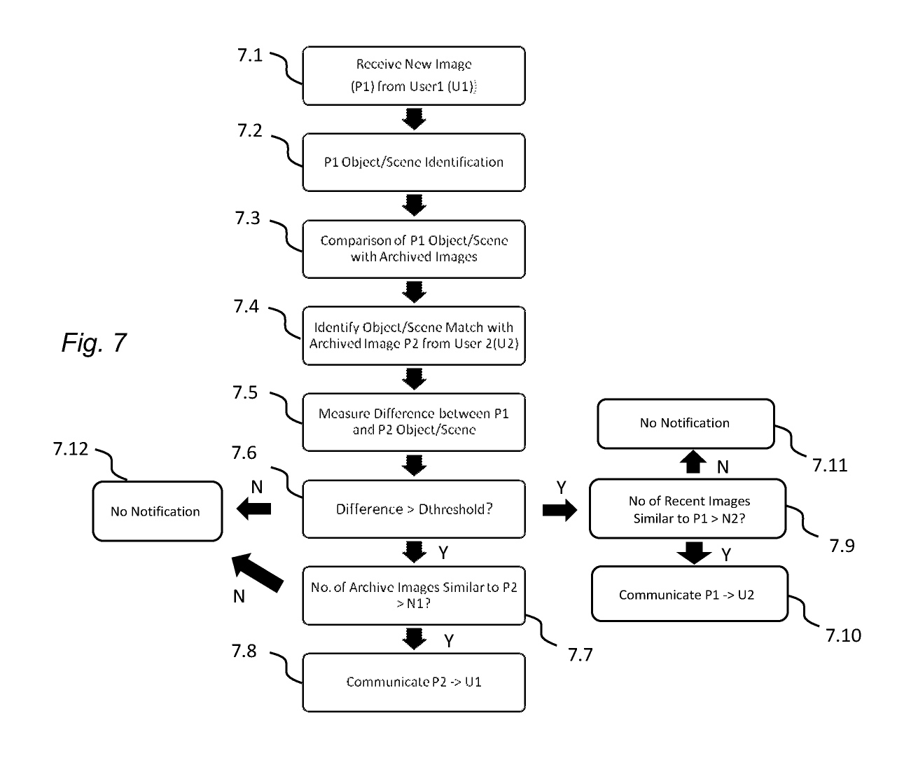

Referring to FIG. 7, processing steps performed by the software application 505 on the photo sharing platform 500 will now be described in relation to a second embodiment.

In this second embodiment, user notifications are again communicated on the basis of differences between common objects or scenes, but in this case only when a predetermined number of similar images are available in the photograph archive 513.

Steps 7.1 to 7.6 are identical to steps 6.1 to steps 6.6 described above, and no further mention is therefore required.

If in step 7.6 the quantified difference between the common object or scene in P1 and P2 is above Dthreshold, then in step 7.7 a determination is made as to whether there are a predetermined minimum number (N1) of images similar to the stored image P2. The difference quantifier applied in step 7.5 is employed for this purpose and it can be supposed that the common object or scene in P2 and other stored images (P3 . . . Pn) will be the same or similar if this difference quantifier is between zero and ten. If N1 is, say, three, then step 7.7 determines whether or not there are three or more similar images to P2 in the photograph archive 513.

If so, in step 7.8, P2 is notified to U1. If not, in step 7.12, no notification is sent.

Additionally, or alternatively to steps 7.7 and 7.8, if in step 7.6 the quantified difference between the common object or scene in P1 and P2 is above Dthreshold, then in step 7.9 a determination is made as to whether there are a predetermined minimum number (N2) of recently-stored images having the common content similar in appearance to the new image P1. If N2 is, say, three, then step 7.9 determines whether or not there are three or more similar recently-stored images to P1 in the photograph archive 513.

If so, in step 7.10, P1 is notified to U2. If not, in step 7.11, no notification is sent.

As in the first embodiment, notification can take a number of forms, including for example transmitting an email or SMS to an account or mobile number associated with U1 including an identifier or link to the relevant image P2. Alternatively, or additionally, the actual image P2 can be pushed to U1's mobile terminal 100 when they open the PNA application.

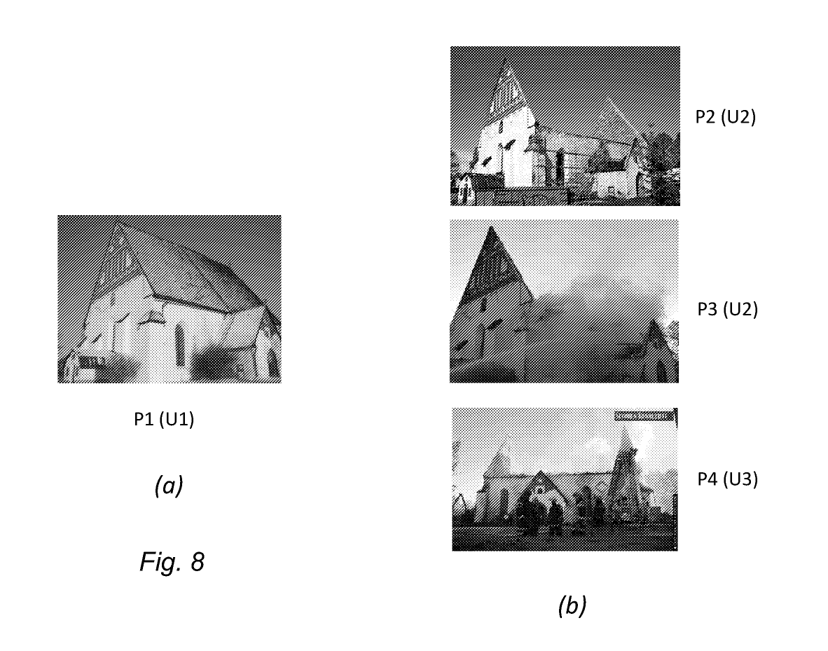

Referring now to FIG. 8, a simple example will be described. FIG. 8(a) shows a new image P1 captured by a user U1 using a mobile terminal 100. The object of interest is identified as the church building in the foreground.

FIG. 8(b) shows three stored photographs P2, P3, P4 identified from the photograph archive 513 as depicting the same church building but with significant differences. P2 and P3 are associated with a user U2 and P4 is associated with a user U3. The processing steps outlined in FIGS. 6 and 7 can be applied to determine if and when notifications are made to users.

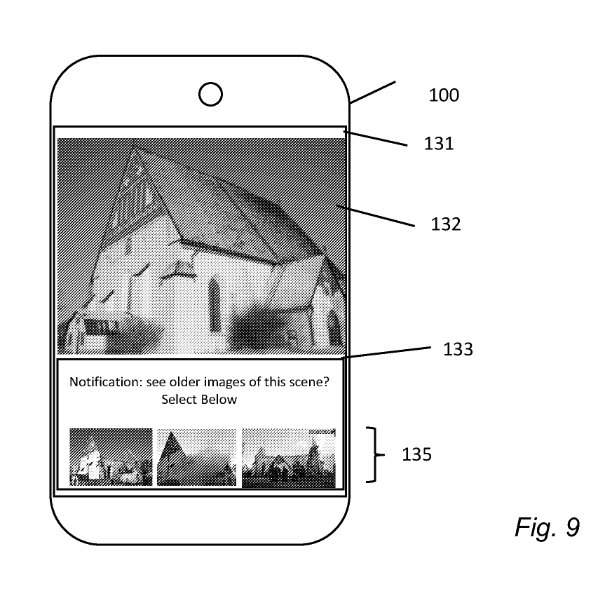

Referring now to FIG. 9, there is shown a user interface which forms part of the PNA application on the mobile terminal 100. The user interface includes a main window 131 in which the new image P1 132 is viewed. The new image P1 can be an image captured through the camera 132 of the mobile terminal 100, or one which is currently stored on the mobile terminal 100 and is being browsed or which the user wishes to upload to the photo sharing platform 500. The user interface also includes a lower window 133 in which notifications from the photo sharing platform 500 are received.

In this case, using the images shown in FIG. 8, on the basis of the extracted church object being transmitted to the photo sharing platform 500, said platform has pushed back to the mobile terminal 100 a notification message and thumbnails 135 of the photos having common content with significant differences.

The above-described embodiments have been described in relation to a network or cloud—based system in which relevant images are notified to users' terminals over a network. The apparatus and method, however, can be applied on an individual user terminal so that a new image captured or uploaded to the terminal is compared with all other images archived on said terminal to notify the user of common content images with appearance differences.

The method is not limited to sharing images associated with other users. Notifications made to users can relate to an image that the same user has previously uploaded.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-14. (canceled)

15. A method comprising:
accessing one or more stored images;
receiving a reference image associated with a user;
identifying an object or scene of interest in the reference image;
comparing the identified object or scene of interest with objects or scenes of interest in the one or more stored images to identify common content having an appearance change; and
communicating automatically to the user associated with the reference image a notification message referencing or comprising the stored image(s) having the identified changed appearance in common content.

16. A method according to claim 15, wherein identifying the object or scene of interest comprises using a predetermined algorithm upon receiving the reference image.

17. A method according to claim 15, wherein identifying the object or scene of interest comprises using selection data manually entered by the associated user and received with the reference image.

18. A method according to claim 15, further comprising quantifying the appearance change in common content, and communicating the notification message only if the quantified change is above a predetermined amount.

19. A method according to claim 18, further comprising communicating the notification message only if there are a predetermined number of other stored images having the same or substantially similar content to the matched image.

20. A method according to claim 15, wherein each stored image is associated with a user, and wherein the method further comprises communicating a second notification message referencing or comprising the reference image to user(s) associated with the stored image(s) having the changed appearance in common content.

21. A method according to claim 20, further comprising identifying stored images having comment content with the received reference image which is of the same or similar appearance, and automatically communicating the second notification message to said user(s) only if a predetermined minimum number of such same or similar appearance images have been identified.

22-29. (canceled)

30. A non-transitory computer-readable storage medium having stored thereon computer-readable code, which, when executed by computing apparatus, causes the computing apparatus to perform a method comprising:
accessing one or more stored images;
receiving a reference image associated with a user;
identifying an object or scene of interest in the reference image;
comparing the identified object or scene of interest with objects or scenes of interest in the one or more stored images to identify common content having an appearance change; and
communicating automatically to the user associated with the reference image a notification message referencing or comprising the stored image(s) having the identified changed appearance in common content.

31. Apparatus, the apparatus having at least one processor and at least one memory having computer-readable code stored thereon which when executed controls the at least one processor:
to access one or more stored images;
to receive a reference image associated with a user;
to identify an object or scene of interest in the reference image;
to compare the identified object or scene of interest with objects or scenes of interest in the one or more stored images to identify common content having an appearance change; and
to communicate automatically to the user associated with the reference image a notification message referencing or comprising the stored image(s) having the identified changed appearance in common content.

32-33. (canceled)

34. Apparatus according to claim 31, wherein the computer-readable code controls the at least one processor to identify the object or scene of interest using a predetermined algorithm upon receiving the reference image.

35. Apparatus according to claim 31, wherein the computer-readable code controls the at least one processor to identify the object or scene of interest using selection data manually entered by the associated user and received with the reference image.

36. Apparatus according to claim 31, wherein the computer-readable code controls the at least one processor to quantify the appearance change in common content, and to communicate the notification message only if the quantified change is above a predetermined amount.

37. Apparatus according to claim 36, wherein the computer-readable code controls the at least one processor to communicate the notification message if there are a predetermined number of other stored images having the same or substantially similar content to the matched image.

38. Apparatus according to claim 31, wherein each stored image is associated with a user, and wherein the computer-readable code controls the at least one processor to communicate a second notification message referencing or comprising the reference image to user(s) associated with the stored image(s) having the changed appearance in common content.

39. Apparatus according to claim 38, wherein the computer-readable code controls the at least one processor to identify stored images having comment content with the received reference image which is of the same or similar appearance, and to communicate the second notification message to said user(s) only if a predetermined minimum number of such same or similar appearance images have been identified.
